(19) United States
(12) Patent Application Publication
(10) Pub. No.: US 2010/0013435 A1
(43) Pub. Date: Jan. 21, 2010

(54) Charging Station

(76) Inventor: Yu-Ta Tu, Taipei (TW)

Correspondence Address: David Shung, P.O. Box 10557, Taipei, 100, TW

(21) Appl. No.: 12/501,508

(22) Filed: Jul. 13, 2009

(30) Foreign Application Priority Data
Jul. 21, 2008 (TW) 097127574

(51) Int. Cl. H02J 7/02

(52) U.S. Cl. 320/109; 320/137; 320/138

(57) ABSTRACT

A charging station for electric vehicles is disclosed. The charging station includes a charge device and a terminal. The terminal is used for monitoring and recording the charging status of the charge device. The charging station can rapidly charge electric vehicles just like gas stations for engine powered vehicles.

### BACKGROUND OF THE INVENTION

1. Technical Field

The invention generally relates to charging stations, particularly to charging stations for electrical vehicles.

2. Related Art

In this period of high price of petroleum, it is certain that petroleum fuel is replaced by electricity, especially for vehicles. At present, the primary problem of electrical vehicles is endurance. Batteries of electrical vehicles need to be charged repeatedly. Thus charging stations are necessary for electrical vehicles just like gas stations for petroleum vehicles. Furthermore, home electric power can charge electrical vehicles, but it will need a long time and complicated process to charge. This is an important reason why the electrical vehicles cannot be very popular.

### SUMMARY OF THE INVENTION

A primary object of the invention is to provide a charging station similar to currently available gas stations. The charging station can rapidly charge batteries of electrical vehicles for solving the endurance problem with less time and simpler process than using home electric power to charge.

To accomplish the above object, the charging station of the invention includes a charge device and a terminal for monitoring and recording the charging status of the charge device. The charge device further includes a plurality of charge units and at least one communication interface. Each of the charge units is composed of:

a filter circuit for filtering noise interference from an alternating current (AC) power source and rectifying AC power into direct current (DC) power;

a power element forming signal on/off cycle for stabilizing output voltage or current;

an isolation and voltage-step-down module for matching the batteries to be charged and for preventing from interference when a charge process is performed by plural charge units in parallel or series;

a feedback amplifier for feedback control; and

a controller receiving signals from the feedback amplifier and communication interface for controlling on/off status of the power element.

### BRIEF DESCRIPTION OF THE DRAWINGS

FIG. 1 shows the arrangement of the charging station of the invention; and

FIG. 2 is a block diagram of the charge device shown in FIG. 1.

### DETAILED DESCRIPTION OF THE INVENTION

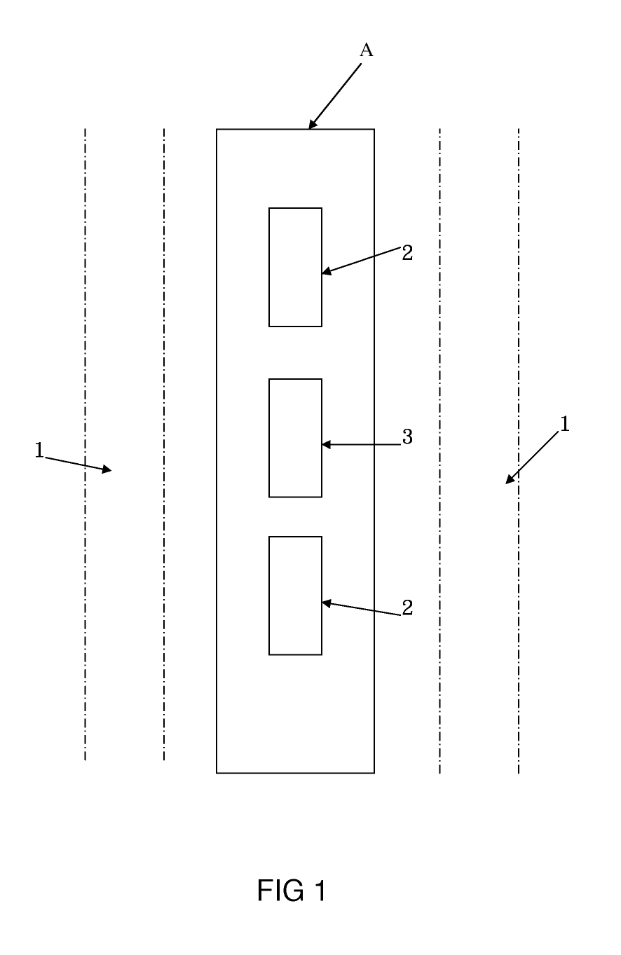

Referring to FIG. 1, the charging station for electrical vehicles of the invention includes at least one charge device 2 arranged at one side of a driveway 1 and a terminal 3 adjacent to the charge device 2. The terminal 3 is used for monitoring and recording the charging status of the charge device. An electrical vehicle which comes into the driveway 1 and stops, its battery can be rapidly charged by the charge device 2 for solving the endurance problem.

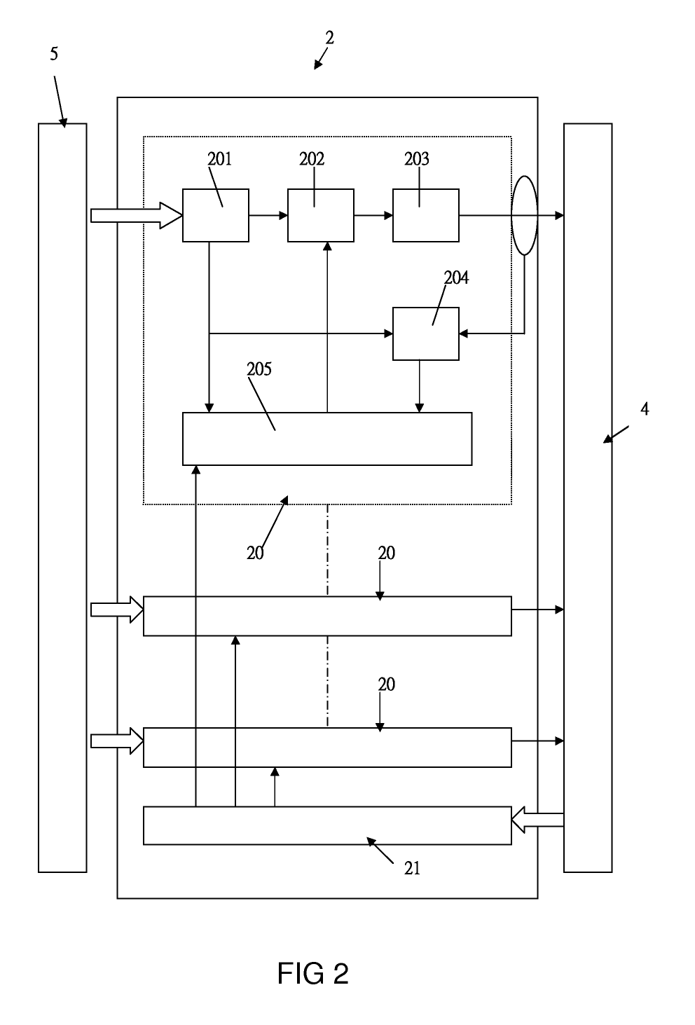

Referring to FIG. 2, the charge device 2 further includes a plurality of charge units 20 and at least one communication interface 21. The communication interface 21 is used for connecting to a battery 4 to be charged. The communication interface 21 can communicate with a protection circuit (not shown) of the battery 4 and obtain some parameters of the battery 4 such as storing capacity.

Each of the charge units 20 is composed of a filter circuit 201, a power element 202, an isolation and voltage-step-down module 203, a feedback amplifier 204 and a controller 205.

An input end of the filter circuit 201 connects to an external alternating current (AC) power source 5 for filtering noise interference from the AC power source 5 and rectifying AC power into direct current (DC) power for supplying power to the other elements and the battery 4 to be charged.

The power element 202 forms signal on/off cycle for stabilizing output voltage or current. One end of the power element 20 is connected to the filter circuit 201, and the other two ends are connected to the isolation and voltage-step-down module 203 and the controller 205 separately. The controller 205 controls the power element 202 to switch on/off according to the signal on/off cycle, thus the isolation and voltage-step-down module 203 is powered by the power element 202 discontinuously.

One end of the isolation and voltage-step-down module 203 is connected to the power element 202 for receiving power from the filter circuit 201. The other end of the isolation and voltage-step-down module 203 is connected to the battery 4 for charging. Meanwhile, the isolation and voltage-step-down module 203 performs isolation and voltage step-down conversion for matching the battery 4 to be charged and for preventing from interference when a charge process is performed by plural charge units 20 in parallel or series;

Two ends of the feedback amplifier 204 are connected to the output end of the isolation and voltage-step-down module 203 and the controller 205, respectively for feedback control. The feedback control can make the controller 205 outputs signals stably.

Three ends of the controller 205 are connected to the feedback amplifier 204, communication interface 21 and the power element 202 respectively, for receiving signals from the feedback amplifier 204 and communication interface 21 for controlling on/off status of the power element 202.

By means of the abovementioned structure, the charging station of the invention can not only charge the batteries of electrical vehicles but also communicate with the batteries charged for preventing the batteries from being damaged.

It will be appreciated by persons skilled in the art that the above embodiment has been described by way of example only and not in any limitative sense, and that various alterations and modifications are possible without departure from the scope of the invention as defined by the appended claims.

What is claimed is:

1. A charging station for charging batteries of electrical vehicles comprising:
a charge device comprising:
at least one communication interface for communicating with the batteries to be charged; and
a plurality of charge units, each of the charge units further comprising:
a filter circuit for filtering noise interference from an alternating current (AC) power source and rectifying AC power into direct current (DC) power;
a power element forming signal on/off cycle for stabilizing output voltage or current;
an isolation and voltage-step-down module for matching the batteries to be charged and for preventing from interference when a charge process is performed by the charge units in parallel or series;
a feedback amplifier for feedback control; and
a controller receiving signals from the feedback amplifier and the communication interface for controlling on/off status of the power element; and
a terminal for monitoring and recording the charging status of the charge device.

2. The charging station of claim 1, wherein the batteries are installed in the electrical vehicles as a primary power.
